(19) United States
(12) Patent Application Publication
(10) Pub. No.: US 2022/0381512 A1
(43) Pub. Date: Dec. 1, 2022

(54) FURNACE AND METHOD FOR OPERATING A FURNACE

(71) Applicant: INNOVATHERM PROF. DR. LEISENBERG GMBH + CO. KG, Butzbach (DE)

(72) Inventors: Detlef MAIWALD, Moers (DE); Frank HEINKE, Weimar (DE)

(21) Appl. No.: 17/638,324

(22) PCT Filed: Aug. 19, 2020
(86) PCT No.: PCT/EP2020/073168

§ 371 Date: Aug. 2, 2022

(30) Foreign Application Priority Data
Aug. 28, 2019 (EP) 19194176.4

(51) Int. Cl. F27B 13/14; F27D 19/00

(52) U.S. Cl. CPC F27B 13/14; F27D 19/00; F27D 2019/0003; F27D 2019/0043

(57) ABSTRACT

The invention relates to a method and a control device for operating a furnace (10), in particular an anode furnace, the furnace being formed by a plurality of heating channels (12) and furnace chambers (13), the furnace chambers serving to receive carbonaceous products, in particular anodes, and the heating channels serving to control the temperature of the furnace chambers, the furnace comprising at least one furnace unit (11), the furnace unit comprising a heating zone (18), a fire zone (19) and a cooling zone (20), which for their part are formed by at least one section (37, 38, 39, 40, 41, 42) comprising furnace chambers, a suction ramp (15) of the furnace unit being disposed in a section of the heating zone, and a burner ramp (16) of the furnace unit being disposed in a section of the fire zone, process air in the heating channels of the fire zone being heated by means of the burner ramp, and exhaust gas being suctioned from the heating channels of the heating zone by means of the suction ramp, an operation of the ramps being controlled by means of a control device of the furnace unit. An amount of fuel of the burner ramp is determined by means of the control device, a ratio of the combustion air and the amount of fuel being determined for at least one section by means of the control device.

The invention relates to a method for operating a furnace, in particular an anode furnace, to a control device for a furnace, and to a furnace, the furnace being formed by a plurality of heating channels and furnace chambers, the furnace chambers serving to receive carbonaceous bodies, in particular anodes, and the heating channels serving to control the temperature of the furnace chambers, the furnace comprising at least one furnace unit, the furnace unit comprising a heating zone, a fire zone and a cooling zone, which for their part are formed by at least one section comprising furnace chambers, a suction ramp of the furnace unit being disposed in a section of the heating zone, and a burner ramp of the furnace unit being disposed in a section of the fire zone, process air in the heating channels of the fire zone being heated by means of the burner ramp, and exhaust gas being suctioned from the heating channels of the heating zone by means of the suction ramp, an operation of the ramps being controlled by means of a control device of the furnace unit.

The present method and the device are used in producing anodes which are needed for fused-salt electrolysis for producing primary aluminum, for example. These anodes or carbonaceous bodies are produced as what is referred to as green anodes or raw anodes from petroleum coke, to which pitch is added as a binder, in a molding process, said green anodes or raw anodes being sintered in an anode furnace or furnace after molding. This sintering process takes place in a heat treatment process which runs in a defined manner and in which the anodes undergo three phases, namely a heating phase, a sintering phase and a cooling phase. In said process, the raw anodes are located in a heating zone of a “fire” formed in a furnace composed of the heating zone, a fire zone and a cooling zone and are pre-heated by the exhaust heat of previously sintered carbonaceous bodies stemming from the fire zone before the pre-heated anodes are heated to the sintering temperature of about 1200° C. in the fire zone. According to the state of the art as known from WO 2013/044968 A1, for example, the different zones mentioned are defined by an alternately continuing arrangement of different units above furnace chambers or heating channels which receive the anodes.

The fire zone, which is disposed between the heating zone and the cooling zone, is defined by the fact that a burner mechanism or one or multiple so-called burner ramps is/are positioned above selected furnace chambers or heating channels. Anodes burned, i.e., heated to sintering temperature, immediately prior are located in the cooling zone. A fan or what is referred to as a cooling ramp, by means of which air is blown into the heating channels of the cooling zone, is disposed above the cooling zone. Through the heating channels, a suction mechanism or what is referred to as a suction ramp disposed above the heating zone transports the air from the cooling zone through the fire zone into the heating zone and, as waste gas or exhaust gas, from there through a waste gas cleaning system and discharges it to the environment. The suction ramp and the burner ramp form a furnace unit together with the cooling ramp and the heating channels.

The units mentioned are shifted along the heating channels in the direction of the raw anodes disposed in the furnace at regular time intervals. For instance, one furnace can comprise multiple furnace units whose units are shifted one after the other above the furnace chambers or the heating channels for subsequent heat treatment of the raw anodes or anodes. Anode furnaces of this kind, which can be configured as open or closed annular kilns in various architectures, present the problem that a volumetric flow rate of the process air or the exhaust gases transported through the furnace cannot be measured directly and only with much effort. For example, it should be ensured that a sufficient amount of oxygen for burning a fuel of the burner mechanism is available in the heating channels of the furnace.

Since the constructive design of the heating channels prevents direct measuring of the volumetric flow rate, the volumetric flow rate is determined indirectly by evaluating pressure and temperature measurements at the heating channels and control signals of a process controller. Alternatively, there have been attempts to determine the volumetric flow rate by indirect measurement, such as a pressure measurement in the heating channel and its ratio to a suction capacity of the suction ramp, as described in more detail in WO 2013/044968 A1. Even in the event of a more precise determination of the volumetric flow rate, however, proper functioning of the furnace according to a desired or ideal burning curve cannot be ensured when a heating channel cover is opened or improperly closed or a heating channel is clogged or blocked, for example.

Hence, in practice, volumetric flow rate assessment is performed by trained furnace personnel in the course of a tour of the furnace and/or by assessing status information of a process controller at regular time intervals. If a malfunction of the furnace caused, for example, by a discrepancy between the volumetric flow rate and the fuel is detected, this malfunction is remedied manually by the furnace personnel or the ratio of the volumetric flow rate or the process air and the fuel is adjusted accordingly. Since a tour of the furnace is carried out at time intervals of up to four hours, for example, dangerous operating states of the furnace which can lead to deflagrations, fires or explosions might not be recognized in time.

Hence, the object of the present invention is to propose a method for operating a furnace and a control device for a furnace by means of which an operation of the furnace can be improved.

This object is attained by a method having the features of claim 1, a control device having the features of claim 20, and a furnace having the features of claim 21.

In the method according to the invention for operating a furnace, in particular an anode furnace, the furnace is formed by a plurality of heating channels and furnace chambers, the furnace chambers serving to receive carbonaceous bodies, in particular anodes, and the heating channels serving to control the temperature of the furnace chambers, the furnace comprising at least one furnace unit, the furnace unit comprising a heating zone, a fire zone and a cooling zone, which for their part are formed by at least one section comprising furnace chambers, a suction ramp of the furnace unit being disposed in a section of the heating zone, and a burner ramp of the furnace unit being disposed in a section of the fire zone, combustion air or process air in the heating channels of the fire zone being heated by means of the burner ramp, and hot air or exhaust gas being suctioned from the heating channels of the heating zone by means of the suction ramp, an operation of the ramps being controlled by means of a control device of the furnace unit, wherein an amount of fuel of the burner ramp is determined by means of the control device, a ratio of the combustion air or process air and the amount of fuel being determined for at least one section by means of the control device.

Fuel, such as gas or oil, is typically burned by means of the burner ramp or burners of the burner ramp, preferably multiple burner ramps. An amount of fuel consumed, i.e., burned, by the burner ramp during a time interval is determined by means of the control device with respect to said time interval. The amount of fuel consumed by the burner ramp, i.e., a primary amount of fuel, can be determined by measuring using a quantity measuring device or the like, for example. Furthermore, an amount of von process air in at least one section, preferably in multiple or all sections, of the heating zone and the fire zone can be determined by means of the control device. This determination can be determined in various ways, such as by measuring pressures or positions of throttle valves relative to a time interval. According to the invention, a ratio of the process air and the amount of fuel is determined for at least one section by means of the control device, preferably within the same time interval. By determining the ratio, which can be easily calculated arithmetically or mathematically by means of a computer program product of the control device, for example, it becomes possible to find out whether the ratio corresponds to a presumed operating state of the furnace or a burning curve or deviates therefrom. In the event of a deviation, an excess or a lack of fuel or process air can lead to critical operating states of the furnace. This deviation can be signaled by the control device, for example, in order to inform the furnace personnel so that the furnace personnel can locate the issue or manually adjust the ratio outside of rotational furnace tours. Alternatively, the control device can also automatically adjust the presumed ratio or control the determined ratio of the process air and the amount of fuel according to the presumed ratio. If no safe operating state can be established, the furnace can be brought into a safe operating state by shutting off the primary fuel supply. Overall, an improved operation of the furnace can be ensured in this way while avoiding dangerous operating states. In particular, high emissions and high fuel consumption can be avoided as well.

A ratio of the process air and the amount of fuel can be calculated for all sections of the heating zone and/or the fire zone, preferably for all sections of the furnace, by means of the control device. Thus, an essentially complete monitoring of the respective zones or the entire furnace with regard to undesired operating states can be ensured. Furthermore, it also becomes possible to adjust the ratio of the process air and the amount of fuel in the different sections in a more targeted manner, in particular since the sections are connected to each other in series, which means that a ratio of the process air and the amount of fuel affects an operating state of the furnace in a flow direction across subsequent sections.

A primary amount of fuel of the burner ramp can be determined by means of the control device, wherein a secondary amount of fuel of the heating zone and/or the burner zone can be determined as a function of at least one chemical property of the anodes or carbonaceous bodies by means of the control device. The primary amount of fuel can be an amount of gas, natural gas, oil or the like which is consumed by the burner ramp or the burner ramps during a time interval, for example. The secondary amount of fuel can be an amount of pitch contained in the carbonaceous bodies or raw anodes, for example. Pitch is typically used as a binder in a molding process of raw anodes. The pitch or pitch distillates can be released at a temperature between 200° C. and 600° C. Depending on the chemical composition of the carbonaceous body or the anode, it contains a greater or smaller amount of pitch, which is known in principle. Depending on the temperature of the individual anode or its heating behavior, a greater or smaller amount of pitch distillate can be released, which burns in the fire zone. This secondary amount of fuel in the form of pitch distillate or other substances contained in the raw anodes and usable as fuel results in a change in a ratio of the amount of fuel and the process air. Hence, it is advantageous for the control device to be able to determine the secondary amount of fuel. According to a particularly simple embodiment, this determination can take place based on an amount of pitch present in the raw anodes, for example. A continuous determination of the secondary amount of fuel can take place by determining the heating of the carbonaceous products and a release of combustible components depending thereon based on a thermodynamic mathematical model, for example.

The primary amount of fuel can be calculated by means of the control device as a function of a temperature measured in the heating channel of the fire zone. Thus, it is no longer necessary to determine an amount of fuel by means of quantity measuring devices, which are consequently unnecessary as well. In principle, it remains possible to determine the primary amount of fuel by direct recordal of pulse times for an oil or gas injection of individual burners. Since a temperature in the heating channel of the fire zone is measured anyway for operating a burner ramp, this temperature can be advantageously used by the control device for calculating the primary amount of fuel. This calculation can be performed using empirical values for fuel consumptions at certain temperatures measured in the fire zone, for example. For instance, the calculation can be performed based on a mathematical function of the primary amount of fuel and the temperature.

The secondary amount of fuel of the heating zone can be calculated or estimated as a function of a mass loss, a degree of coking and/or a temperature of the anodes or carbonaceous bodies. Consequently, the secondary amount of fuel can be calculated by the control device by means of a mathematical model. A heat content or a temperature of the carbonaceous bodies has an impact on the release of pitch distillates, for example, which means that a proportion of the primary amount of fuel released by the carbonaceous bodies during a time interval can be calculated by means of the control device when a chemical property of the carbonaceous bodies, such as a mass fraction of pitch, a dwell time of the carbonaceous bodies in the furnace, a temperature level of the carbonaceous bodies during this time interval, therefore a degree of coking and therefore also a mass loss are known. A temperature of carbonaceous bodies in different sections can be measured directly. Direct measuring of a temperature can also be performed on individual carbonaceous bodies as a reference measurement. The control device can store and recalculate these measured values for a carbonaceous body or anode depending on the position of the carbonaceous body in a section or zone so that the control device can continuously adjust a degree of coking for the carbonaceous body at hand and therefore a secondary amount of fuel represented by the carbonaceous body.

The control device can calculate the temperature of the carbonaceous bodies. In addition to directly measuring the temperature of the anodes or carbonaceous bodies by means of sensors or other measurement devices, the control device can also calculate the temperature of the carbonaceous bodies by means of a mathematical model. This calculation can take the temperatures in the heating channels of the furnace measured by the control device into account. Furthermore, the respective temperatures at the suction ramp, at the burner ramp and in heating channels of other sections can be measured. The control device can calculate the temperature of the respective carbonaceous bodies from these temperatures of the furnace, which are essentially measured simultaneously. This calculation can take other operating parameters of the furnace into account. The calculation can also be performed based on empirical values, which are represented by mathematical functions, for example. In this case, direct measuring of the temperature of the carbonaceous bodies is no longer required during regular operation of the furnace.

The control device can calculate a total amount of fuel from the primary amount of fuel and the secondary amount of fuel. In particular, this makes it possible for the amount of fuel burned in the area of the burner ramp and composed of the primary amount of fuel and the secondary amount of fuel to be determined even more precisely. In this way, the amounts of fuel supplied to the heating channels in the heating zone and in the fire zone can be determined more precisely, wherein the required ratios of these amounts of fuel to residual oxygen contained in the exhaust gas can be determined for optimal combustion. Consequently, a ratio of the process air and the amount of fuel can also be determined more precisely.

A volumetric flow rate of the sections between the suction ramp and the cooling ramp can be determined by means of the control device based on a pressure measured in the heating channel or other physical parameters in the heating channel. This volumetric flow rate can be calculated by the control device by means of a mathematical model. For example, a pressure in the heating channel can be measured in each section and at the exit of the fire zone.

The volumetric flow rate in the heating channel can be determined by means of the control device from a ratio of the suction capacity and the pressure in the suction ramp and a ratio of the suction capacity and the pressure in the heating channel. The respective ratios can each be formed separately and the volumetric flow rate can be derived therefrom.

Respective pressures in a plurality of heating channels can be correlated with the pressure in the suction ramp. A volumetric flow rate can also be determined individually for individual heating channels if the pressure in the individual section is known, the pressure in the sections being correlated with the pressure in the suction ramp. Since a pressure deviation in a heating channel affects the pressures in the other heating channels or sections, a changed volumetric flow rate can be determined or calculated with a relative correlation to the pressure measured in the suction ramp.

The suction capacity of the suction ramp can be determined by means of the control device by determining a valve position of a throttle valve of the suction ramp. A cross section of a suction channel can be varied by adjusting the throttle valve with the result that the suction capacity of the suction ramp depends inter alia on the adjusted cross section of the suction channel. If a throttle valve or a similar feature of this kind is used, a suction capacity can therefore be deduced from a valve position, which is indicated in angular degrees relative to the suction channel, for example. A valve position can be determined in a particularly simple and precise manner by means of a rotary potentiometer or a rotary encoder, for example.

It is particularly advantageous for the volumetric flow rate in the heating channel of the heating zone and/or the fire zone to be determined. Since differences in the volumetric flow rate due to the burning method may arise in this context, they can be taken into account in this manner. For instance, volumetric flow rates in the heating channels of the zones mentioned above can each be determined separately. Thus, a differentiated view of the operating state in the respective zones of the furnace becomes possible. Also, the volumetric flow rate can be determined even more precisely if a change in density of air in the heating channel is calculated from a temperature gradient across the respective sections or heating channels and the temperature, and this change in density is taken into account when determining the volumetric flow rate. Hence, a calculation of the volumetric flow rate can be corrected by a correction factor which can be derived from a calculation of the change in density based on the temperature gradient and the temperature.

Furthermore, an enthalpy flow rate of the sections can be determined by means of the control device. The enthalpy flow rate can also be calculated by the control device by means of a mathematical model. The enthalpy flow rate can be easily calculated through a ratio of respective pressures and respective volumetric flow rates in a plurality of heating channels.

A consistency of the volumetric flow rate and the enthalpy flow rate can be calculated by means of the control device, wherein potential amounts of false air of the heating channels can be determined based on said calculation. If the volumetric flow rate and the enthalpy flow rate deviate from a presumed ratio, this can point to a possible malfunction. In this context, respective amounts of false air for the respective heating channels may be determined based on the comparative calculation of the volumetric flow rate and the enthalpy flow rate by means of the control device. The amount of false air can be a result of improperly closed heating channel covers or at least partially blocked heating channels, for example. The amount of false air can be calculated by the control device by means of a mathematical model. The amount of false air can be calculated iteratively, for example, based on empirical values represented by mathematical functions.

Furthermore, an amount of air introduced into the heating channels and potential amounts of false air can be determined by means of the control device. The amount of air introduced into the heating channels can be determined at a fan ramp in the area of the cooling zone, for example. The amount of air at the fan ramp can be determined by determining a valve position of a throttle valve. A cross section of a suction channel can be varied by adjusting the throttle valve with the result that the amount of air introduced depends inter alia on the adjusted cross section of the suction channel. If a throttle valve or a similar feature of this kind is used, a suction capacity or an amount of air can therefore be deduced from a valve position, which is indicated in angular degrees relative to the suction channel, for example. The amount of air can be used by the control device to calculate the volumetric flow rate. Alternatively, an introduced amount of air can be determined by measuring the pressure in the heating channels between the fan ramp and the burner ramp. Furthermore, it is possible for an introduced amount of air to be determined via a speed of ventilators.

A total volumetric flow rate can be determined by means of the control device from the volumetric flow rate, a volumetric fuel flow rate and the amount of false air. In this case, the total volumetric flow rate or the introduced amount of air, the amount of false air and a volume of the amount of fuel represent the process air made available during a time interval, in particular oxygen for the amount of fuel used during said time interval. The volumetric fuel flow rate results from the volume of the used amount of fuel in the process air. If a primary amount of fuel and a secondary amount of fuel are known, a primary volumetric fuel flow rate and a secondary volumetric fuel flow rate can be taken into account when determining the total volumetric flow rate. The ratio of the process air and the amount of fuel can be determined even more precisely in this manner.

The control device can correct the volumetric flow rate and/or the enthalpy flow rate. This correction of the calculated volumetric flow rate or the enthalpy flow rate can take place taking other operating parameters, such as an amount of false air or other measured data, into account.

The volumetric flow rate, preferably of the sections and/or the suction ramp and/or the cooling ramp, and/or an introduced amount of air can be adjusted in such a manner by means of the control device that a target ratio of the process air and the primary amount of fuel and/or the secondary amount of fuel, preferably of the total amount of fuel, can be reached, the target ratio being defined in the control device. The control device can calculate a current ratio of the process air and the amount of fuel and control it according to the target ratio by adjusting the introduced amount of air. To this end, the control device can have one or multiple controllers, such as PID controllers. Thus, it is possible to ensure at all times that a ratio of the process air and the amount of fuel does not deviate to a point at which dangerous operating states arise. Also, a state which is optimal for a combustion of the different fuels can be established.

This adjustment can take place by a control of the volumetric flow rate at the suction ramp and/or the cooling ramp by means of the control device. This control of the volumetric flow rate can be accomplished by actuating throttle valves at the suction ramp and/or the cooling ramp. The control can act on a motor drive of the throttle valve or throttle valves with the result that the volumetric flow rate is influenced.

Furthermore, the primary amount of fuel introduced can be adjusted in such a manner by means of the control device that a target ratio of the process air and the total amount of fuel can be reached, the target ratio being defined in the control device. Consequently, controlling a current ratio of the process air and the total amount of fuel by metering the amount of fuel at the burner ramp is possible as well. The primary amount of fuel can be controlled in connection with a control of the volumetric flow rate, in which case the control device can also establish a cascade control.

The control device according to the invention is configured to operate a furnace, in particular an anode furnace, the furnace being formed by a plurality of heating channels and furnace chambers, the furnace chambers serving to receive carbonaceous bodies, in particular anodes, and the heating channels serving to control the temperature of the furnace chambers, the furnace comprising at least one furnace unit, the furnace unit comprising a heating zone, a fire zone and a cooling zone, which for their part are formed by at least one section comprising furnace chambers, a suction ramp of the furnace unit being disposed in a section of the heating zone, and a burner ramp of the furnace unit being disposed in a section of the fire zone, the burner ramp being configured to heat process air in the heating channels of the fire zone, and the suction ramp being configured to suction exhaust gas from the heating channels of the heating zone, the control device of the furnace unit being configured to control an operation of the ramps, wherein the control device is configured to determine an amount of fuel of the burner ramp, the control device being configured to determine a ratio of the process air and the amount of fuel for at least one section. Reference is made to the description of advantages of the method according to the invention regarding the advantages of the control device according to the invention. Further advantageous embodiments of a control device are apparent from the description of features of the dependent claims referring to method claim 1.

The furnace, in particular the anode furnace, according to the invention comprises a control device according to the invention. Further embodiments of a furnace are apparent from the description of features of the depending claims referring to method claim 1.

Hereinafter, a preferred embodiment of the invention is explained in more detail with reference to the accompanying drawings.

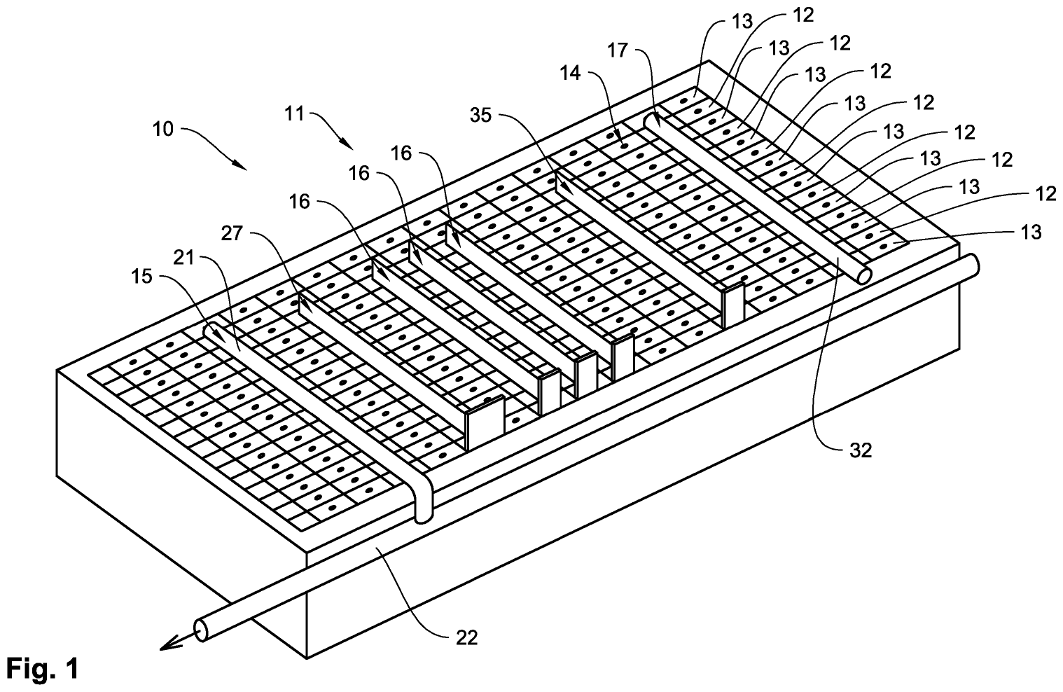

FIG. 1 is a schematic illustration of a furnace in a perspective view;

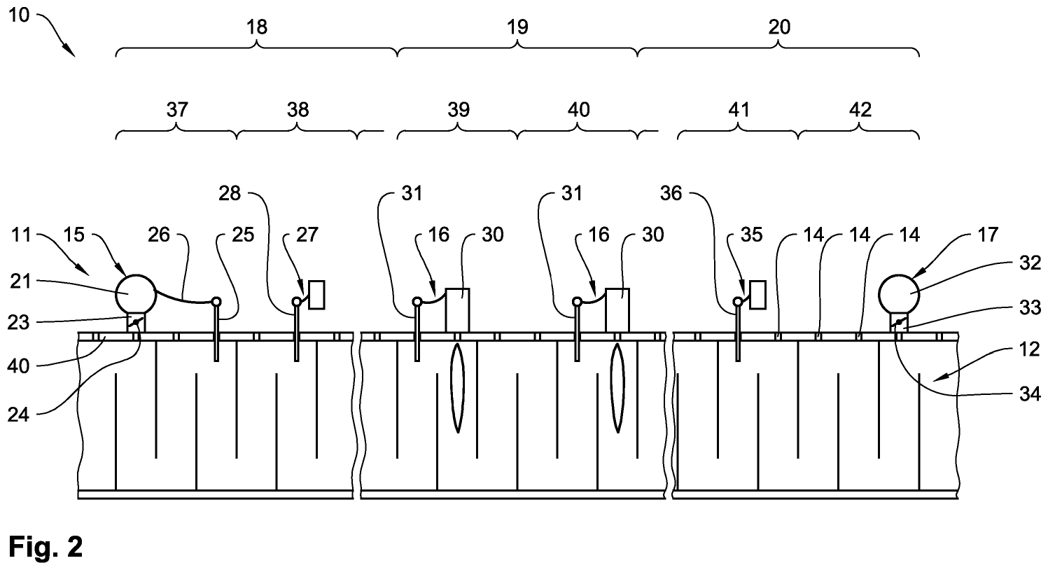

FIG. 2 is a schematic illustration of a furnace unit of the furnace in a longitudinal section view;

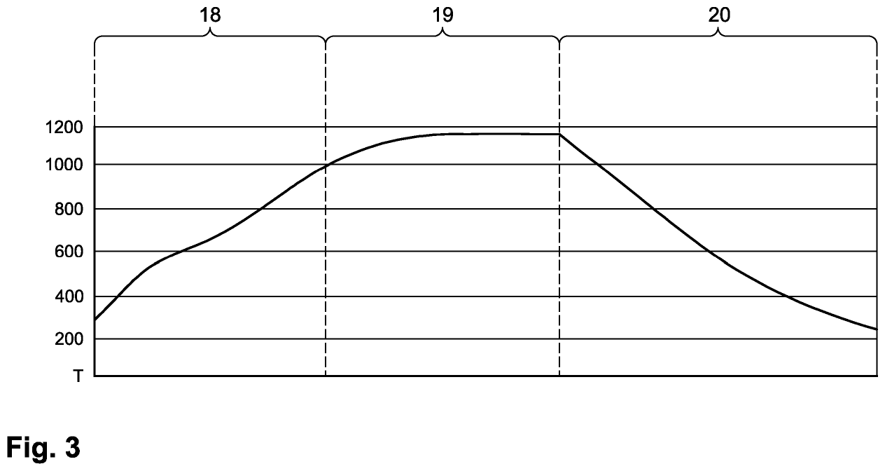

FIG. 3 shows a temperature distribution in the furnace unit;

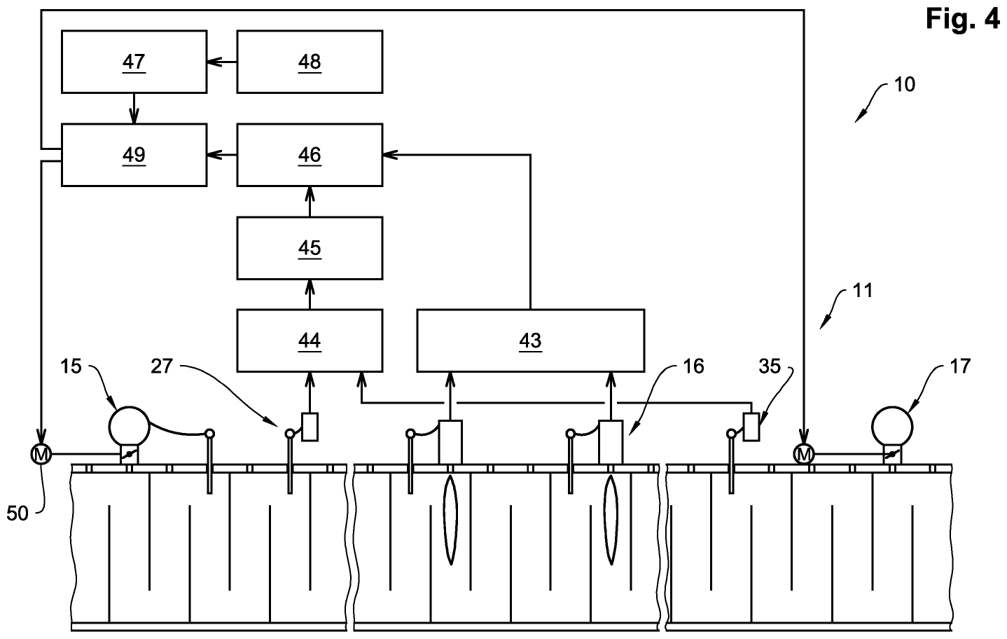

FIG. 4 is an illustration of the furnace unit of FIG. 2 with a process diagram for an embodiment of the method for operating a furnace.

A combined view of FIGS. 1 and 2 shows a schematic illustration of an anode furnace or furnace 10 comprising a furnace unit 11. Furnace 10 has a plurality of heating channels 12, which extend parallel to each other along interposed furnace chambers 13. Furnace chambers 13 serve to accommodate anodes or carbonaceous bodies (not shown). Heating channels 12 extend in a meandering shape in the longitudinal direction of furnace 10 and have heating channel openings 14 at regular intervals, which are each covered by a heating channel cover (not shown).

Furnace unit 11 further comprises a suction ramp 15, one or multiple burner ramps 16 and a cooling ramp 17. Their positions on furnace 10 functionally define a heating zone 18, a fire zone 19 and a cooling zone 20, respectively. In the course of the production process of the anodes or carbonaceous bodies, furnace unit 11 is displaced in the longitudinal direction of furnace 10 relative to furnace chambers 13 or carbonaceous bodies by shifting suction ramp 15, burner ramps 16 and cooling ramp 17 with the result that all anodes or carbonaceous bodies located in anode furnace 10 pass through zones 18 to 20.

Suction ramp 15 is essentially formed by a collecting channel 21, which is connected to an exhaust gas cleaning system (not shown) via an annular channel 22. Collecting channel 21 for its part is connected to a heating channel opening 14 via a connecting channel 23 in each case, a throttle valve 24 being disposed on connecting channel 23 in the case at hand. Furthermore, a measuring element (not shown) for pressure measuring is disposed within collecting channel 21, and another measuring element 25 for temperature measuring is disposed in each heating channel 12 directly upstream of collecting channel 21 and is connected thereto via a data line 26. Moreover, a measuring ramp 27 comprising measuring elements 28 for each heating channel 12 is disposed in heating zone 18. A pressure and a temperature in the respective portion of heating channel 12 can be determined by means of measuring ramp 27.

Three burner ramps 16 comprising burners 30 and measuring elements 31 for each heating channel 12 are placed in fire zone 19. Burners 30 each burn a flammable fuel in heating channel 12, a burner temperature being measured by means of measuring element 31. This makes it possible for a desired burner temperature to be set in the area of fire zone 19.

Cooling zone 20 comprises cooling ramp 17, which is formed by a feeding channel 32 comprising respective connecting channels 33 and throttle valves 34 for being connected to heating channels 12. Fresh air is blown into heating channels 12 via feeding channel 32. The fresh air cools heating channels 12 or the anodes or carbonaceous bodies located in furnace chambers 13 in the area of cooling zone 20, the fresh air continuously heating up until it reaches fire zone 19. In this context, FIG. 3 shows a diagram of the temperature distribution relative to the length of heating channel 12 and zones 18 to 20. Furthermore, a measuring ramp 35 or what is referred to as a zero pressure ramp comprising measuring elements 36 is disposed in cooling zone 20. Measuring elements 36 serve to detect a pressure in respective heating channels 12. The pressure in heating channel 12 is essentially 0 in the area of measuring elements 36, a high pressure forming between measuring elements 36 and cooling ramp 17, and a low pressure forming in heating channels 12 between measuring elements 36 and suction ramp 15. Consequently, the fresh air flows from cooling ramp 17 through heating channels 12 toward suction ramp 15. Ramps 15 to 17 are each disposed in sections 37 to 42, sections 37 to 42 for their part each being formed by heating channel portions 12. Sections adjacent to sections 37 to 42 are not shown for the sake of clarity of the figure.

FIG. 4 shows furnace unit 11, which has been illustrated in FIG. 2, in connection with a process flow for operating furnace 10, the process flow being illustrated as an example. In particular, an operation of suction ramp 15, burner ramp 16 and cooling ramp 17 is controlled by means of a control device (not shown) of furnace unit 11, the control device comprising at least one means for data processing, such as a programmable logic controller or a computer, which is used to execute a computer program product or at least one software. A ratio of the process air and the amount of fuel is determined for at least one of sections 37 to 42 by means of the control device.

A primary amount of fuel of burner ramps 16 is determined by means of the control device in a method step 43. Furthermore, a temperature of the anodes or carbonaceous bodies (not shown) is calculated by means of the control device in a method step 44. This can also take place by measuring a temperature via measuring ramp 27 and/or measuring ramp 35. Furthermore, a secondary amount of fuel of heating zone 18 is calculated by means of the control device as a function of at least one chemical property of the anodes or carbonaceous bodies, in particular a temperature, in a method step 45. In a method step 46, the control device calculates a total amount of fuel from the primary amount of fuel and the secondary amount of fuel.

Furthermore, the control device calculates a volumetric flow rate in sections 37 to 42 or suction ramp 15 based on a pressure measured in heating channel 12 in a method step 47. The volumetric flow rate can be determined by the control device based on a ratio of the suction capacity and the pressure in suction ramp 15 and a ratio of the suction capacity and the pressure in heating channel 12, for example. Furthermore, an enthalpy flow rate in sections 37 to 42 is calculated in method step 47. In a method step 48, the control device determines a consistency of the volumetric flow rate and the enthalpy flow rate, potential amounts of false air in the heating channels 12 being determined by the control device based on a calculation. The control device uses potential amounts of false air to correct the volumetric flow rate in method step 47.

In method step 49, the control device calculates a ratio of an amount of air introduced or process air and the total amount of fuel from the volumetric flow rate from method step 47 and the total amount of fuel from method step 46. Furthermore, a target ratio of the process air and the total amount of fuel is defined in the control device, which means that a comparison of the ratios is drawn in method step 49. The control device now controls the volumetric flow rate at suction ramp 15 based on the comparison by adjusting throttle valve 24 by means of an actor 50 in such a manner that the desired target ratio of the process air and the amount of fuel is established. The primary amount of fuel introduced can also be controlled through the control device in order to control the ratio. Overall, this can ensure at all times that the ratio of the process air and the amount of fuel does not cause dangerous operating states; moreover, the operation of furnace 10 can be optimized.

1. A method for operating a furnace (10), in particular an anode furnace, the furnace being formed by a plurality of heating channels (12) and furnace chambers (13), the furnace chambers serving to receive carbonaceous bodies, in particular anodes, and the heating channels serving to control the temperature of the furnace chambers, the furnace comprising at least one furnace unit (11), the furnace unit comprising a heating zone (18), a fire zone (19) and a cooling to zone (20), which for their part are formed by at least one section (37, 38, 39, 40, 41, 42) comprising furnace chambers, a suction ramp (15) of the furnace unit being disposed in a section of the heating zone, and a burner ramp (16) of the furnace unit being disposed in a section of the fire zone, process air in the heating channels of the fire zone being heated by means of the burner ramp, and exhaust gas being suctioned from the heating channels of the heating zone by means of the suction ramp, an operation of the ramps being controlled by means of a control device of the furnace unit,
characterized in that
an amount of fuel of the burner ramp is determined by means of the control device, a ratio of the process air and the amount of fuel being determined for at least one section by means of the control device.

2. The method according to claim 1,
characterized in that
a ratio of the process air and the amount of fuel is calculated for all sections (37, 38, 39, 40, 41, 42) of the heating zone (18) and/or the fire zone (19), preferably for all sections of the furnace (10), by means of the control device.

3. The method according to claim 1 or 2,
characterized in that
a primary amount of fuel of the burner ramp (16) is determined by means of the control device, a secondary amount of fuel of the heating zone (18) and/or the burner zone (19) being determined by means of the control device as a function of at least one chemical property of the carbonaceous bodies.

4. The method according to claim 3,
characterized in that
the primary amount of fuel is calculated by means of the control device as a function of a temperature measured in the heating channel (12) of the fire zone (19).

5. The method according to claim 3 or 4,
characterized in that
the secondary amount of fuel of the heating zone (18) is calculated as a function of a mass loss, a degree of coking and/or a temperature of the carbonaceous bodies.

6. The method according to claim 5,
characterized in that
the control device calculates a temperature of the carbonaceous bodies.

7. The method according to any one of claims 3 to 6,
characterized in that
the control device calculates a total amount of fuel from the primary amount of fuel and the secondary amount of fuel.

8. The method according to any one of claims 3 to 7,
characterized in that
a volumetric flow rate of the sections (37, 38, 39, 40, 41, 42) between the suction ramp (15) and the cooling ramp (17) is determined by means of the control device based on a pressure measured in the heating channel (12) or other physical parameters in the heating channel.

9. The method according to claim 8,
characterized in that
the volumetric flow rate in the heating channel is determined by means of the control device from a ratio of a suction capacity and the pressure in the suction ramp (15) and a ratio of the suction capacity and the pressure in the heating channel (12).

10. The method according to claim 9,
characterized in that
respective pressures in a plurality of heating channels (12) are correlated with the pressure in the suction ramp (15).

11. The method according to claim 8 or 9,
characterized in that
the suction capacity of the suction ramp (15) is determined by means of the control device by determining a valve position of a throttle valve (24) of the suction ramp.

12. The method according to any one of claims 8 to 11,
characterized in that
an enthalpy flow rate of the sections (37, 38, 39, 40, 41, 42) is determined by means of the control device.

13. The method according to claim 12,
characterized in that
a consistency of the volumetric flow rate and the enthalpy flow rate is calculated by means of the control device, potential amounts of false air of the heating channels (12) being determined based on said calculation.

14. The method according to any one of claims 8 to 13,
characterized in that
an amount of air introduced into the heating channels (12) and potential amounts of false air are determined by means of the control device.

15. The method according to claim 14,
characterized in that
a total volumetric flow rate is determined by means of the control device from the volumetric flow rate, a volumetric fuel flow rate and the amount of false air.

16. The method according to any one of claims 8 to 15,
characterized in that
the control device corrects the volumetric flow rate and/or the enthalpy flow rate.

17. The method according to any one of claims 8 to 16,
characterized in that
the volumetric flow rate, preferably of the sections (37, 38, 39, 40, 41, 42) and/or the suction ramp (15) and/or the cooling ramp (17), and/or an amount of air introduced are adjusted in such a manner by means of the control device that a target ratio of the process air and the primary amount of fuel and/or the secondary amount of fuel, preferably of the total amount of fuel, is reached, the target ratio being defined in the control device.

18. The method according to claim 17,
characterized in that
said adjustment takes place by a control of the volumetric flow rate at the suction ramp (15) and/or the cooling ramp (17) by means of the control device.

19. The method according to claim 17 or 18,
characterized in that
the primary amount of fuel introduced is adjusted in such a manner by means of the control device that a target ratio of the process air and the total amount of fuel is reached, the target ratio being defined in the control device.

20. A control device for operating a furnace (10), in particular an anode furnace, the furnace being formed by a plurality of heating channels (12) and furnace chambers (13), the furnace chambers serving to receive carbonaceous bodies, in particular anodes, and the heating channels serving to control the temperature of the furnace chambers, the furnace comprising at least one furnace unit (11), the furnace unit comprising a heating zone (18), a fire zone (19) and a cooling zone (23), which for their part are formed by at least one section (37, 38, 39, 40, 41, 42) comprising furnace chambers, a suction ramp (15) of the furnace unit being disposed in a section of the heating zone, and a burner ramp (16) of the furnace unit being disposed in a section of the fire zone, the burner ramp being configured to heat process air in the heating channels of the fire zone, and the suction ramp being configured to suction exhaust gas from the heating channels of the heating zone, the control device of the furnace unit being configured to control an operation of the ramps,
characterized in that
the control device is configured to determine an amount of fuel of the burner ramp, the control device being configured to determine a ratio of the process air and the amount of fuel for at least one section.

21. A furnace, in particular an anode furnace, comprising a control device according to claim 20.
